(19) United States
(12) Patent Application Publication
(10) Pub. No.: US 2026/0122525 A1
(43) Pub. Date: Apr. 30, 2026

(54) DELAY OFFSET BASED CSI

(71) Applicant: Samsung Electronics Co., Ltd., Suwon-si (KR)

(72) Inventors: Gilwon Lee, Prosper, TX (US); Eko Onggosanusi, Coppell, TX (US)

(21) Appl. No.: 19/348,733

(22) Filed: Oct. 2, 2025

Related U.S. Application Data
(60) Provisional application No. 63/712,835, filed on Oct. 28, 2024.
(60) Provisional application No. 63/713,396, filed on Oct. 29, 2024.
(60) Provisional application No. 63/720,476, filed on Nov. 14, 2024.

(51) Int. Cl. H04W 24/10; H04L 5/00

(52) U.S. Cl. CPC H04W 24/10; H04L 5/0051

(57) ABSTRACT

Apparatuses and methods for delay offset based channel state information (CSI) reporting. A method performed by a user equipment (UE) includes receiving information related to a first CSI report and a second CSI report. The information indicates for the first CSI report, N_{TRP} CSI reference signal (CSI-RS) resource sets, N_{TRP}>1, and a report quantity set to ‘cjtc-Dd’ and, for the second CSI report, N_{TRP} CSI-RS resources and a codebook type set to ‘typeII-CJT-r18’. The first CSI report is associated with the second CSI report. The information for the second CSI report includes an aperiodic CSI trigger state and a radio resource control (RRC) parameter, ‘delayOffsetCompensation-r19’ set to ‘enabled’. The method further includes determining, based on the information, CSI by compensating delay offset values and transmitting the second CSI report including the CSI. The delay offset values are reported values in a latest report of the first CSI report.

### CROSS REFERENCE TO RELATED APPLICATIONS AND CLAIM OF PRIORITY

The present application claims priority under 35 U.S.C. § 119 (e) to U.S. Provisional Patent Application No. 63/712,835 filed on Oct. 28, 2024; U.S. Provisional Patent Application No. 63/713,396 filed on Oct. 29, 2024; and U.S. Provisional Patent Application No. 63/720,476 filed on Nov. 14, 2024, which are hereby incorporated by reference in their entirety.

### TECHNICAL FIELD

The present disclosure relates generally to wireless communication systems and, more specifically, the present disclosure is related to apparatuses and methods for delay offset based channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to multi-CSI reporting.

In one embodiment, a user equipment (UE) is provided. The UE includes a transceiver configured to receive information related to a first channel state information (CSI) report and a second CSI report. The information indicates for the first CSI report, N_{TRP} CSI reference signal (CSI-RS) resource sets, N_{TRP}>1, and a report quantity set to ‘cjtc-Dd’ and, for the second CSI report, N_{TRP} CSI-RS resources and a codebook type set to ‘typeII-CJT-r18’. The first CSI report is associated with the second CSI report. The information for the second CSI report includes an aperiodic CSI trigger state and a first radio resource control (RRC) parameter, ‘delayOffsetCompensation-r19’ set to ‘enabled’. The UE further includes a processor operably coupled to the transceiver. The processor is configured to determine, based on the information, CSI by compensating delay offset values. The delay offset values are reported values in a latest report of the first CSI report. The transceiver is further configured to transmit the second CSI report including the CSI.

In another embodiment, a base station (BS) is provided. The BS includes a processor and a transceiver operably coupled to the processor. The transceiver is configured to transmit information related to a first CSI report and a second CSI report and receive the second CSI report including CSI. The information indicates for the first CSI report, N_{TRP} CSI-RS resource sets, N_{TRP}>1, and a report quantity set to ‘cjtc-Dd’ and, for the second CSI report, N_{TRP} CSI-RS resources and a codebook type set to ‘typeII-CJT-r18’. The first CSI report is associated with the second CSI report. The information for the second CSI report includes an aperiodic CSI trigger state and a first RRC parameter, ‘delayOffsetCompensation-r19’ set to ‘enabled’. The CSI is based on compensation of delay offset values and wherein the delay offset values are reported values in a latest report of the first CSI report.

In yet another embodiment, a method performed by a UE is provided. The method includes receiving information related to a first CSI report and a second CSI report. The information indicates for the first CSI report, N_{TRP} CSI-RS resource sets, N_{TRP}>1, and a report quantity set to ‘cjtc-Dd’ and, for the second CSI report, N_{TRP} CSI-RS resources and a codebook type set to ‘typeII-CJT-r18’. The first CSI report is associated with the second CSI report. The information for the second CSI report includes an aperiodic CSI trigger state and a first RRC parameter, ‘delayOffsetCompensation-r19’ set to ‘enabled’. The method further includes determining, based on the information, CSI by compensating delay offset values and transmitting the second CSI report including the CSI. The delay offset values are reported values in a latest report of the first CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example antenna port layout according to embodiments of the present disclosure;

FIG. 11 illustrates examples of a UE moving on a trajectory with antenna groups (AGs) of the BS co-located and distributed a UE moving on a trajectory located in co-located and distributed according to embodiments of the present disclosure; and

FIG. 12 illustrates an example method performed by a UE in a wireless communication system according to embodiments of the present disclosure.

### DETAILED DESCRIPTION

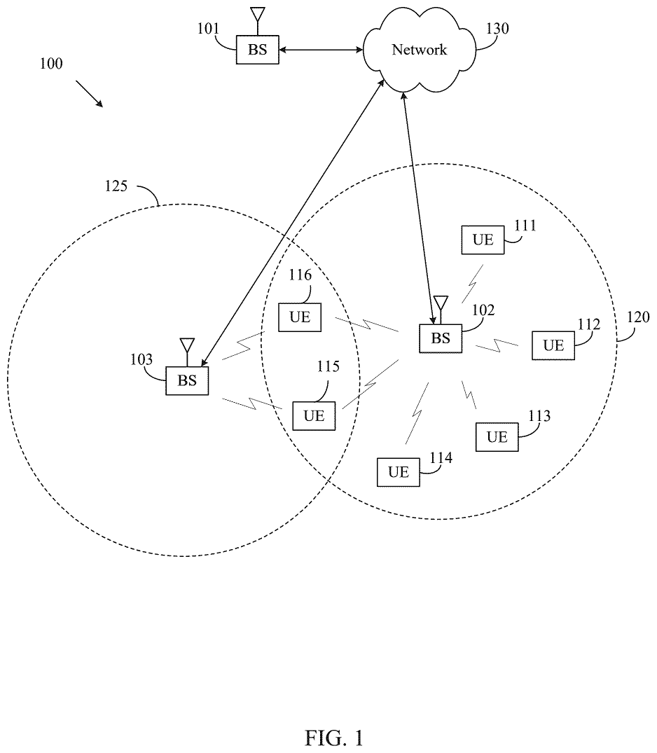

FIGS. 1-12 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v18.0.1, “E-UTRA, Physical channels and modulation;” [REF 2] 3GPP TS 36.212 v18.0.0, “E-UTRA, Multiplexing and Channel coding;” [REF 3] 3GPP TS 36.213 v18.2.0, “E-UTRA, Physical Layer Procedures;” [REF 4] 3GPP TS 36.321 v18.3.0, “E-UTRA, Medium Access Control (MAC) protocol specification;” [REF 5] 3GPP TS 36.331 v18.3.1, “E-UTRA, Radio Resource Control (RRC) Protocol Specification;” [REF 6] 3GPP TR 22.891 v1.2.0; [REF 7] 3GPP TS 38.212 v18.4.0, “E-UTRA, NR, Multiplexing and Channel coding;” [REF 8] 3GPP TS 38.214 v18.4.0, “E-UTRA, NR, Physical layer procedures for data;” [REF 9] 3GPP TS 38.211 v18.4.0, “E-UTRA, NR, Physical channels and modulation;” [REF 10] 3GPP TS 38.213 v18.4.0, “E-UTRA, NR; Physical layer procedures for control;” and [REF 11] 3GPP TS 38.331 v18.3.0, “E-UTRA, NR; Radio Resource Control (RRC); Protocol specification.”

FIGS. 1-12 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing delay offset based CSI reporting. In certain embodiments, one or more of the BSs 101-103 include circuitry, programing, or a combination thereof to support multi-CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

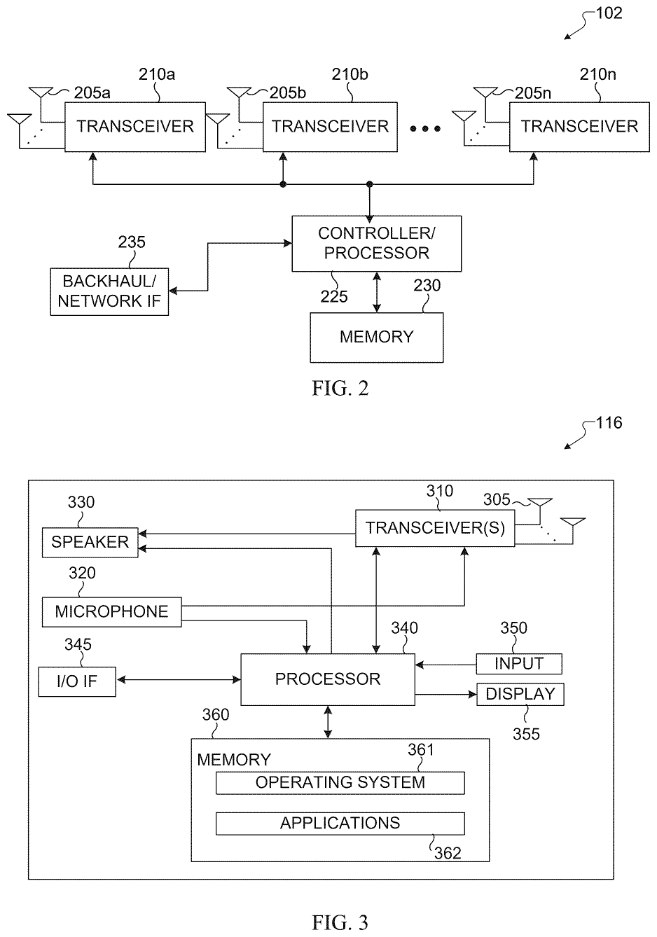

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for delay offset based CSI reporting. Any of a wide variety of other functions could be supported in the gNB 102 by the controller/processor 225.

The controller/processor 225 is also capable of executing programs and other processes resident in the memory 230, such as processes to support delay offset based CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for delay offset based CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

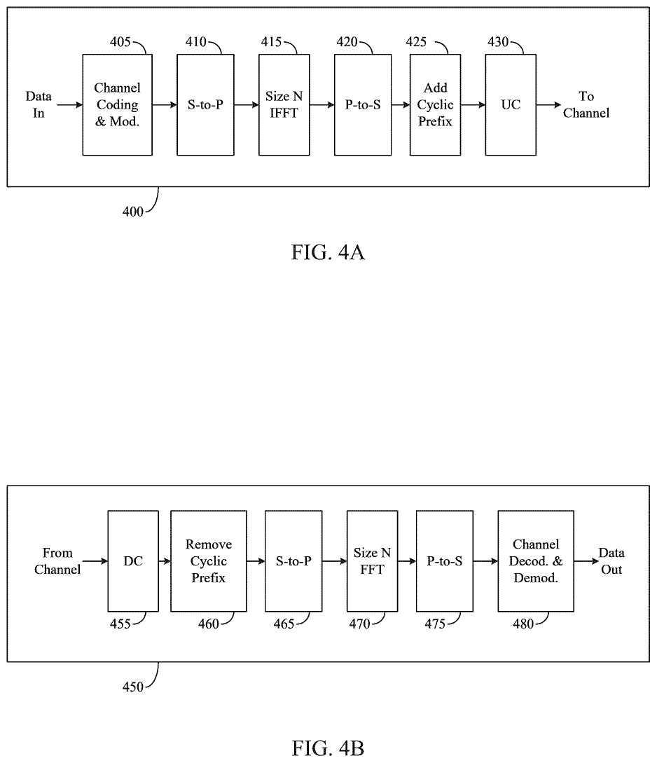

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for delay offset based CSI reporting as described in embodiments of the present disclosure. In some embodiments, the receive path 450 is configured for delay offset based CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

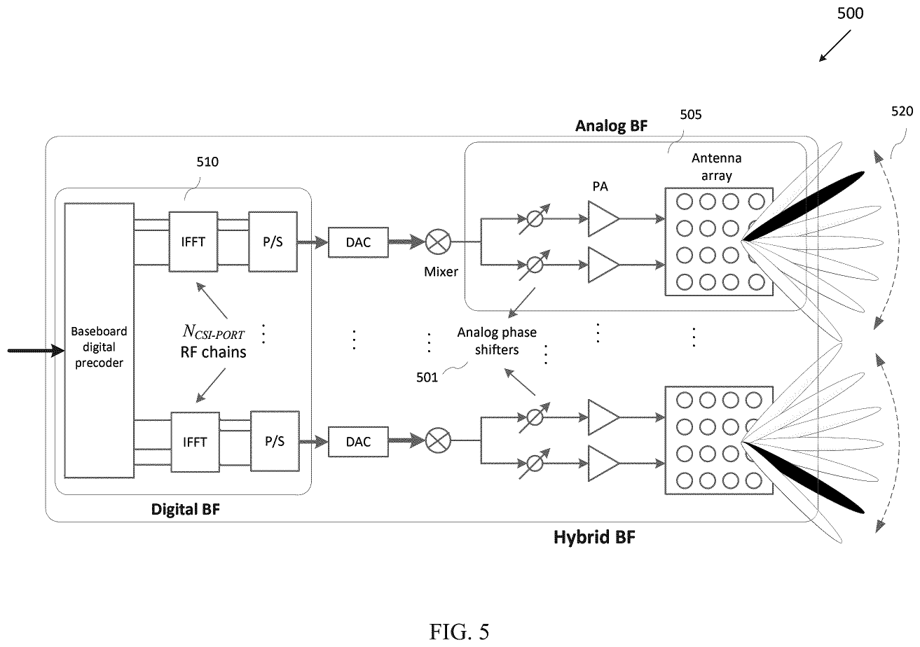

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

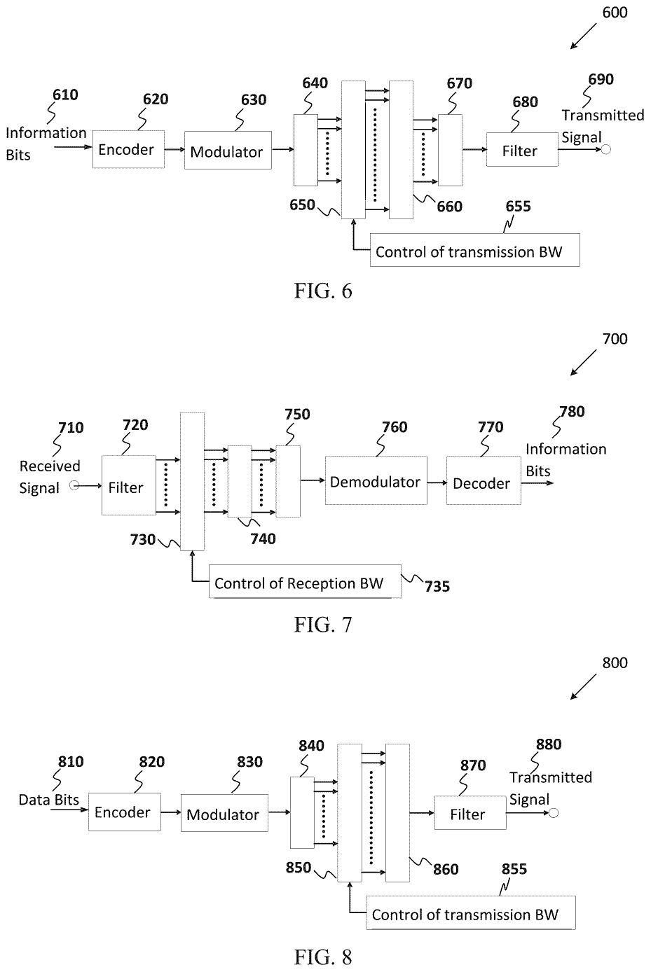

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

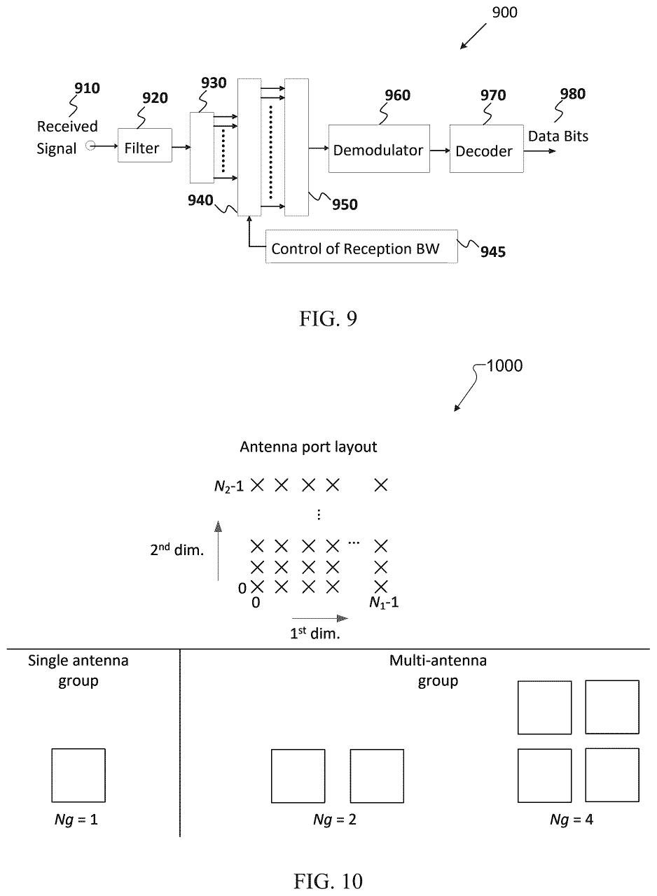

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

The present disclosure relates generally to wireless communication systems and, more specifically, to antenna calibration and multi-CSI reporting.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred as an eNodeB. For NR systems, a NodeB is often referred as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka CRS in LTE or tracking reference signal (TRS) in NR), for CSI reporting. DMRS can be transmitted only in the BW of a respective PDSCH, and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)-see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information radio network temporary identifier (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{s c}^{R B}$$

sub-carriers, or Kesource Elements (REs), such as 12 REs. A unit of one RB over one subframe (or slot) is referred to as a PRB. A UE can be allocated MPDSCH RBs for a total of

$${M}_{sc}^{P D S C H} = {M}_{P D S C H} \cdot {N}_{sc}^{R B}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes

$${N}_{s y m b}^{UL}$$

symbols for transmitting data information, UCI, DMRS, or SRS. A frequency resource unit of an UL system BW is a RB. A UE is allocated NRB RBs for a total of

$${N}_{R B} \cdot {N}_{s c}^{R B}$$

KES for a transmission DW. A last few subframe (or slot) symbols can be used to multiplex SRS transmissions from one or more UEs.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range designation | Corresponding frequency range |
|---|---|
| FR1 | 450 MHz-6000 MHz |
| FR2 | 24250 MHz-52600 MHz |

For MIMO in FR1, up to 32 CSI-RS antenna ports in one CSI-RS resource is supported, and in FR2, up to 8 CSI-RS antenna ports in one CSI-RS resource is supported. A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital.

In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In next generation cellular standards (e.g. 6G), in addition to FR1 and FR2, new carrier frequency bands can be provided, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Embodiments of the present disclosure recognize that due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE.

In 5G or NR systems [REF7, REF8], both low-(aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients \tilde{W}₂ that linearly combine SD and FD bases. For a (full TDD or partial FDD) reciprocity, CSI-RS ports can be beamformed (using SRS measurements, expecting UL-DL channel reciprocity in angular/delay), and the SD basis corresponds to a port selection basis.

In Rel. 18, the FD-compression-based Type II CSI is further enhanced for the use case of CJT across up to 4 TRPs, under the idealistic assumptions such as perfectly time and frequency synchronized mTRPs, phase-coherent antenna ports and ideal backhaul links. In practice, however, these assumptions are not valid, and calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. In the case of the mTRP system, such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.
Issue 1: In one example, the timing offset can be expressed as Tₜ=e^{j2πf(t+Δt)}, where Δt is due to timing difference between (distributed, non-co-located) TRPs or/and different propagation delays from different TRPs, which amounts to increased frequency-selectivity of the composite channel. The min freq. granularity (supported in NR) is 2 RBs (for precoding matrix indicator (PMI)) and 4 RBs (CQI), which correspond to a max delay spread 2.8 and 1.4 micro second for SCS=15 and 30 kHz, respectively. This delay spread decreases further with increasing freq. granularity (due to timing offset). For large delay spread, the required freq. granularity for CJT (across TRPs) will be smaller than 2 RBs.

TABLE 0.5
(Table 9.6.1.3-1: OTA frequency error minimum requirement)

| BS class | Accuracy | |
|---|---|---|
| Wide Area BS | ±0.05 | ppm |
| Medium Range BS | ±0.1 | ppm |
| Local Area BS | ±0.1 | ppm |

Issue 2: In one example, the frequency offset can be expressed as T_{f}=e^{j2π(f+Δf)t}, where Δf is due to non-ideal (and different) local oscillators or crystal types at different TRPs, which results in frequency differences between TRPs. As shown herein, the min freq. error=0.05 ppm, according to TS 38.104. The phase change due to freq. error can be significant, especially at higher carrier frequencies.

In general, the combined (time-frequency) T-F offset can be expressed as T_{t,f}=e^{j2π(f+Δf)(t+Δt)}. For CJT feasibility, (Δt, Δf) needs to be calibrated for frequently.
Issue 3: non-ideal backhaul links between TRPs, especially when the backhaul links are not fiber-optic cables.
Issue 4: phase-coherency across antenna ports, both intra-TRP (within each TRP) and inter-TRP (across TRPs).

In this disclosure, the mechanism and procedures are provided for Issue 1 and 2, which are more severe than Issue 3 and 4.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

This disclosure provides CSI reporting based on calibration-related information (CLI). The calibration-related information such as delay-offset and/or frequency offset values can be reported via a new feature being developed in Rel-19 CJT calibration reporting on PUSCH. This disclosure provides a framework to report CSI for CJT, where the CSI is computed/determined with expecting pre-compensation (at the UE side) utilizing the calibration-related information. The provided aspects as follows:
An RRC signaling framework for indicating separate triggering or joint triggering
An RRC signaling framework for indicating an association or mapping between the set of CSI-RS resources/resource set for a CLI report and the set of CSI-RS resources/resource set for a CSI report
Introduce UCI packing order of two linked CSI reports, when the two linked CSI reports are configured with a joint trigger

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE (e.g., the UE 116) can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g. via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

FIG. 10 illustrates an example antenna port layout 1000 according to embodiments of the present disclosure. For example, antenna port layout 1000 can be implemented by the BS 102 of FIG. 2. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 10 where “X” represents two antenna polarizations. In this disclosure, the term “polarization” refers to a group of antenna ports with the same polarization. For example, anemia ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna payouts are provided in this disclosure. The embodiments (and examples) in this disclosure however are general and are applicable to single-polarized antenna layouts as well.

Let N_{g} be a number of antenna groups (AGs). When there are multiple antenna groups (N_{g}>1), each group (g∈{1, . . . , N_{g}}) comprises dual-polarized antenna ports with N_{1,g} and N_{2,g} ports in two dimensions. This is illustrated in FIG. 10. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g} (for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a non-zero power (NZP) CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g. comprising a CSI-RS resource set).

In one example, an antenna group corresponds to a reconfigurable intelligent surface (RIS) in which the antenna group can be (re-)configured more dynamically (e.g. via MAC CE or/and DCI). For example, the number of antenna ports associated with the antenna group can be changed dynamically.

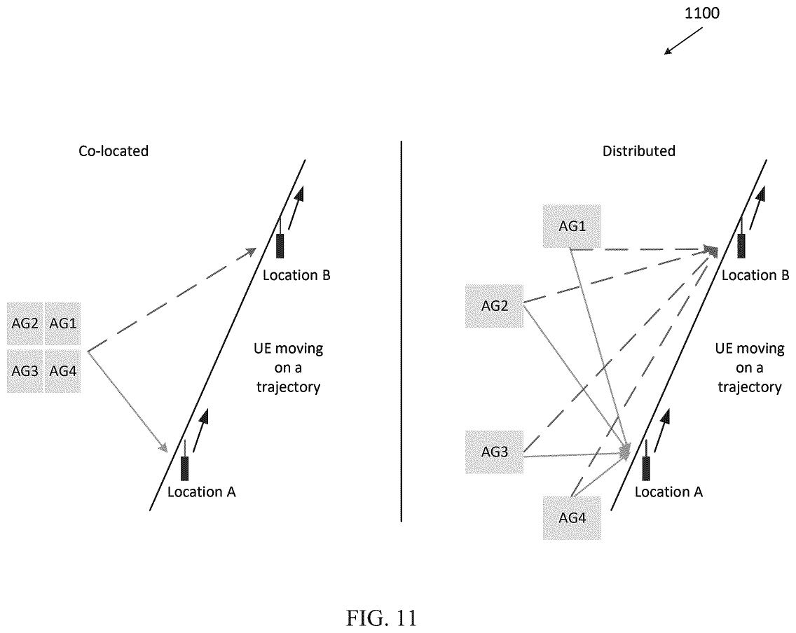

FIG. 11 illustrates examples of a UE moving on a trajectory 1100 with AGs of the BS co-located and distributed according to embodiments of the present disclosure. For example, trajectory 1100 with AGs of the BS co-located and distributed can be implemented by any of the UEs 111-116 of FIG. 1. This example is for illustration only and can be used without departing from the scope of the present disclosure.

In one example scenario, multiple AGs can be co-located or distributed, and can serve static (non-mobile) or moving UEs. An illustration of AGs serving a moving UE is shown in FIG. 11. While the UE moves from a location A to another location B, the UE measures the channel, e.g. via NZP CSI-RS resources, (may also measure the interference, e.g. via CSI-IM resources or CSI-RS resources for interference measurement), uses the measurement to determine/report CSI or calibration-related information considering joint transmission from multiple AGs.

In one example, the antenna architecture of the MIMO system is structured. For example, the antenna structure at each AG is dual-polarized (single or multi-panel as shown in FIG. 10. The antenna structure at each AG can be the same. Or the antenna structure at an AG can be different from another AG. Likewise, the number of ports at each AG can be the same. Or the number of ports at one AG can be different from another AG.

In another example, the antenna architecture of the MIMO system is unstructured. For example, the antenna structure at one AG can be different from another AG.

A structured antenna architecture is provided in the rest of the disclosure. For simplicity, each AG is equivalent to a panel (cf. FIG. 10), although, an AG can have multiple panels in practice. The disclosure however is not restrictive to a single panel assumption at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are explained herein in this disclosure.
In one example, an AG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are explained herein in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g. an RRC parameter). Or it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource (according to one or more examples described herein) or resource group (according to one or more examples described herein) when the codebook corresponds to a decoupled codebook (modular or separate codebook for each AG), and an AG corresponds to a subset (or a group) of CSI-RS ports (according to one or more examples described herein) when codebook corresponds to a coupled (joint or coherent) codebook (one joint codebook across AGs).

In one example, when AG maps (or corresponds to) a CSI-RS resource or resource group (according to one or more examples described herein), and a UE can select a subset of AGs (resources or resource groups) and report the CSI or calibration-related information for the selected AGs (resources or resource groups), the selected AGs can be reported via an indicator (e.g. via UCI part 1 of a two-part UCI). For example, the indicator can be a channel quality indicator (CQI) report interval (CRI) or a PMI (component) or a new indicator (e.g. a bitmap).

In one example, when AG maps (or corresponds to) a CSI-RS port group (according to one or more examples described herein), and a UE can select a subset of AGs (port groups) and report the CSI or calibration-related information for the selected AGs (port groups), the selected AGs can be reported via an indicator (e.g. via UCI part 1 of a two-part UCI). For example, the indicator can be a CRI or a PMI (component) or a new indicator (e.g. a bitmap).

In one example, CSI-RS herein in this disclosure comprises at least one or a combination of the following: CSI-RS for tracking (TRS), CSI-RS for CSI, CSI-RS for beam management (BM), CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), or/and to perform one or more DL RS reception(s)/measurement(s), and/or to report calibration-related information (e.g., for calibration coefficient for each TRP).

This configuration can be performed via higher-layer (RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.

In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or synchronization signal/physical broadcast channel (SSB/PBCH) or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage=AntennaSwitching, or UL DMRS. In one example, UL RS can be a dedicated or new UL RS (for calibration purpose).

In one example, the DL RS(s) can be aperiodic (AP) only.

In one example, the DL RS(s) can be AP or semi-persistent (SP).

In one example, the DL RS(s) can be AP or periodic (P).

In one example, the DL RS(s) can be SP or P.

In one example, the DL RS(s) can be AP or SP or P.

In one example, the UL RS(s) can be aperiodic (AP) only.

In one example, the UL RS(s) can be AP or semi-persistent (SP).

In one example, the UL RS(s) can be AP or periodic (P).

In one example, the UL RS(s) can be SP or P.

In one example, the UL RS(s) can be AP or SP or P.

In one example, the reporting can only be AP. In this case, the reporting can be triggered via a DCI (e.g. a CSI request field in UL-DCI).

In one example, the reporting can either be AP or SP. For AP, the reporting can be triggered via a DCI (e.g. a CSI request field in UL-DCI), and for SP, it can be triggered via MAC CE or DCI.

In one example, the reporting can only be UE-initiated (or UE-triggered). In this case, the reporting can be triggered via UL MAC CE (e.g. MAC CE for power headroom report (PHR) reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or transmission configuration indication (TCI) state, or spatialRelationInfo) or source RS or spatial filter, beamformer, beamforming vectors/matrices, precoding vector/matrices, or any other functionally equivalent quantity, that can be used for DL/UL RS reception/transmission.

In one embodiment, a UE is configured (via higher-layer signaling or MAC-CE or DCI) with a report including CSI for Nₜᵣₚ≥1 TRPs or AGs or CSI-RS resources, where the CSI (e.g., RI/PMI/CQI) is calculated/determined based on a calibration-related information (CLI). In one example, the report can be configured via higher-layer parameter CSI-ReportConfig with codebookConfig set to ‘codebookConfig-r18’ (e.g., Rel-18 CJT Type-II CSI). In one example, the report can be configured via higher-layer parameter CSI-ReportConfig with codebookConfig set to a new value (i.e., a quantity relevant to CSI). In one example, the CLI includes information in one or more of the examples described in this disclosure. For example, the information includes quantities of the calibration reporting described in one or more of the examples in this disclosure. In one example, the CLI corresponds to (or includes) the information that the UE reports for a configured calibration reporting described in one of the examples described in this disclosure.

The CSI can be calculated/determined at the UE assuming pre-compensation based on the CLI information (e.g., delay offset, when ReportQuantity set to ‘cjtc-Dd’). This can facilitate UE-specific delay offset pre-compensation at the NW (or gNB) since it can avoid UE-specific CSI-RS transmission (which incurs CSI-RS overhead).

In one embodiment, the CLI for determining/calculating the CSI can be either implicitly or explicitly configured.

In one example, the CLI for determining/calculating the CSI includes information that the UE is configured to report for a calibration reporting (e.g., reportQuantity set to ‘cjtc-Dd’ or ‘cjtc-F’, ‘cjtc-Dd-F’). For example, the CSI is calculated/determined assuming (delay/frequency offset) pre-compensation utilizing the information that UE is configured to report (or reported) for the calibration reporting.

In one example, the information is associated with (or corresponds to) a latest calibration reporting. In this case, the CSI can be calculated/determined using the information that the UE reported in the latest calibration reporting from the time that the UE receives CSI-RS resource(s) (or DL RS(s)) for the CSI reporting.

In one example, the information is associated with (or corresponds to) a latest calibration reporting. In this case, the CSI can be calculated/determined using the information that the UE reported in the latest calibration reporting from the time that the UE reports the CSI.

In one example, linking information of the CLI reporting (e.g., CJT-C reporting) and the CSI reporting (e.g., Rel-18 CJT Type-II CSI reporting) can be configured by higher-layer signaling (i.e., RRC). In another example, linking information of the CLI reporting and the CSI reporting (e.g., Rel-18 CJT Type-II CSI reporting) can be configured by MAC-CE or DCI.

In one example, a linked CLI reporting in a report configuration of CSI reporting can be configured via higher-layer signaling (i.e., RRC) or MAC-CE, DCI.

In one embodiment, the UE is configured (or triggered via DCI or MAC-CE or higher-layer signaling) to (jointly) report the CSI and CLI, (i.e., the report includes both the CSI and CLI), where the CSI and CLI are multiplexed and reported in a same slot (i.e., a same PUSCH) (or different slots).

In one example, the CSI is determined/calculated assuming pre-compensation (at the UE) utilizing the CLI that is multiplexed with the CSI and reported in a same slot (a same PUSCH).

In one example, the CSI report and the CLI report (e.g., a joint report of them) are triggered by a (same) trigger state via DCI in a aperiodic manner (or a semi-persistent or periodic manner), where the CSI report and CLI report are associated with the trigger state.

In one example, the joint report of the CSI and CLI can be configured (or triggered) only when delay offset reporting is configured for the CLI reporting (e.g., reportQuantity is set to ‘cjtc-Dd’).

In one example, the joint report of the CSI and CLI can be configured (or triggered) only when frequency offset reporting is configured for the CLI reporting (e.g., reportQuantity is set to ‘cjtc-F’).

In one example, the joint report of the CSI and CLI can be configured (or triggered) only when delay offset reporting or joint reporting of delay-offset and frequency-offset is configured for the CLI reporting (e.g., reportQuantity is set to ‘cjtc-Dd’ or ‘cjtc-Dd-F’).

In one example, when the delay offset reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, this is because delay offset reporting already contains TRP selection information.

In one example, when the frequency offset reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, when ‘invalid’ state is indicated for a TRS set(s) (TRPs) for the CLI reporting, the corresponding TRP(s) or CSI-RS resource(s) can be regarded as not selected TRPs.

In another example, when the joint report of the CSI and CLI is configured, the UE is not expected to be configured with enabling TRP selection (e.g., restrictedCMR-selection) for the CSI reporting.

In another example, when the joint report of the CSI and CLI is configured, the UE follows the configured information on enabling TRP selection (e.g., restrictedCMR-selection) for the CSI reporting.

In one example, the joint report of the CSI and CLI is conveyed in a single CSI report.

In one example, the joint report of the CSI and CLI is conveyed in a separate CSI report, respectively.

In one example, the CLI for determining/calculating the CSI can be configured by NW, and the UE calculates/determines the CSI based on the configured CLI. In one example, delay offset and/or frequency offset values for each of the TRPs (or AGs or CSI-RS resources) are explicitly configured to the UE for the CSI report (e.g., Rel-18 CJT CSI reporting).

In one example, a set of configurable delay offset values is the same as a set of possible reported delay offset values from calibration reporting (e.g., when reportQuantity set to ‘cjtc-Dd’ or ‘cjtc-Dd-F’).

In one example, a set of configurable delay offset values is different from a set of possible reported delay offset values from calibration reporting (e.g., when reportQuantity set to ‘cjtc-Dd’ or ‘cjtc-Dd-F’).

In one example, a set of configurable frequency offset values is the same as a set of possible reported frequency offset values from calibration reporting (i.e., when reportQuantity set to ‘cjtc-F’ or ‘cjtc-Dd-F’).

In one example, a set of configurable frequency offset values is different from a set of possible reported frequency offset values from calibration reporting (i.e., when reportQuantity set to ‘cjtc-F’ or ‘cjtc-Dd-F’).

In one embodiment, Nₜᵣₚ CSI-RS resources for the CSI reporting and Nₜᵣₚ CSI-RS resource sets for the CLI reporting follow a pre-defined mapping rule or an implicitly configured rule, or an explicitly configured rule.

In one example, the lowest index of CSI-RS resource configured for the CSI reporting corresponds to the lowest index of CSI-RS resource set configured for the CLI reporting, and the second lowest index of CSI-RS resource configured for the CSI reporting corresponds to the second lowest index of CSI-RS resource set configured for the CLI reporting, and so on.

In one embodiment, the report includes TRP (CSI-RS resource) selection indicator via Nₜᵣₚ-bit (or N(≤Nₜᵣₚ)-bit) bitmap to indicate the TRP or CSI-RS resource for which the UE is not able to perform pre-compensation utilizing the CLI.

In one example, the report includes the indicator regardless of restrictedCMR-Selection set to enabled or not.

In one embodiment, there is restriction for configuring the CSI reporting. In one example, the UE is not expected to be configured with the CSI reporting, associated with the CLI reporting, where a dynamic range of delay offset is configured to a certain value. For example, the dynamic range of A_{D}<x CP can be configurable. For example, x=1. For example, the UE is not expected to be configured with dynamic range of A_{D}=1 CP or dynamic range of A_{D}>1 CP.

In one embodiment, a CSI reporting based on a CLI reporting can be configured according to UE capability.

In one example, the capability of a joint triggering to trigger CSI report and CLI report (e.g., ‘cjtc-Dd’, ‘cjtc-F’, ‘cjtc-Dd-F’, or others) multiplexed in a same PUSCH (or in a same PUSCH slot) is a separate UE Group feature based on a UE capability. In one example, the capability of a joint triggering is an optional feature of UE capability. In another example, the capability of a joint triggering is a basic feature of UE capability.

In one example, the capability of linking CSI report with CLI report (e.g., ‘cjtc-Dd’, ‘cjtc-F’, ‘cjtc-Dd-F’, or others) is a separate UE Group feature based on a UE capability. In one example, the capability of linking CSI report is an optional feature of UE capability. In another example, the capability of linking CSI report is a basic feature of UE capability.

In one example, the capability of CSI report with configuring explicit delay/frequency offset values is a separate UE Group feature based on a UE capability. In one example, the capability of CSI report with configuring explicit delay/frequency offset values is an optional feature of UE capability. In another example, the capability of CSI report with configuring explicit delay/frequency offset values is a basic feature of UE capability.

In one embodiment, time-domain behavior of a CSI-RS resource setting or a CSI report setting for a CSI reporting based on a CLI reporting can be according to at least one of the following examples.

In one example, aperiodic (AP) CSI-RS can (only) be configured in the CSI-RS resource setting for measurement.

In one example, AP/semi-persistent (SP) CSI-RS can (only) be configured in the CSI-RS resource setting for measurement.

In one example, AP/SP/periodic (P) CSI-RS can (only) be configured in the CSI-RS resource setting for measurement.

In one example, SP/P CSI-RS can (only) be configured in the CSI-RS resource setting for measurement.

In one example, AP CSI reporting can (only) be triggered or configured to perform for the CSI reporting.

In one example, AP/SP CSI reporting can (only) be triggered or configured to perform for the CSI reporting.

In one example, AP/SP/P CSI reporting can (only) be triggered or configured to perform for the CSI reporting.

In one example, SP/P CSI reporting can (only) be triggered or configured to perform for the CSI reporting.

In one embodiment, a UE can be configured with a first CSI report (e.g., Rel-19 CJT calibration (CLI) report) and a second CSI report (e.g., Rel-18 CJT Type-II CSI report) via higher-layer signaling (e.g., RRC), where the second CSI report is determined based on at least one content (or report quantity) of the first CSI report (called ‘linkage’ between two CSI reports), and the first CSI report is associated with a first CSI report setting (e.g., a higher-layer IE CSI-ReportConfig ID 11) and a first CSI resource setting (e.g. a higher layer IE CSI-ResourceConfig ID J1), and the second CSI report is associated with a second CSI report setting (e.g. a higher layer IE CSI-ReportConfig ID 12) and a second CSI resource setting (e.g. a higher layer IE CSI-ResourceConfig ID J2). In one example, the first CSI report and the second CSI report are jointly triggered via DCI (or MAC-CE or RRC) to report on a same PUSCH slot or instance, e.g. a code point of a CSI request field indicating either a joint CSI trigger state for I=(I1,I2) or a pair of CSI trigger states I1,I2. In another example, the first CSI report and the second CSI report are separately triggered via DCI (or MAC-CE or RRC) to separately perform reporting, e.g. two separate code points or CSI request fields on one DCI or two DCIs.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to (Rel-18) CJT CSI reporting, e.g., with codebookType set to ‘typeI1-CJT-r18’.

In one example, the first CSI report corresponds to CJT calibration reporting (CLI reporting) e.g., with RRC parameter ‘reportQuantity’ set to ‘cjtc-Dd’ (Delay offset reporting).

In one example, the first CSI report corresponds to CJT calibration reporting (CLI reporting) e.g., with RRC parameter ‘reportQuantity’ set to ‘cjtc-F’ (frequency-offset reporting).

In one example, the first CSI report corresponds to CJT calibration reporting (CLI reporting) e.g., with RRC parameter ‘reportQuantity’ set to ‘cjtc-P’ (phase-offset reporting).

In one example, the first CSI report corresponds to CJT calibration reporting (CLI reporting) e.g., with RRC parameter ‘reportQuantity’ set to ‘cjtc-Dd-F’ (Delay-offset and frequency-offset reporting).

In one example, the second CSI report corresponds to (Rel-18) CJT CSI reporting e.g., with RRC parameter ‘codebookType’ set to ‘typeII-CJT-r18’ (Rel-18 CJT CSI reporting).

In one example, the second CSI report corresponds to (Rel-19) Type-I multi-panel (MP) CSI reporting.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to a PMI-based CSI report with reportQuantity=RI/PMI/CQI or LI/RI/PMI/CQI or CRI/RI/PMI/CQI or CRI/LI/RI/PMI/CQI.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to a non-PMI-based CSI report with reportQuantity=RI/CQI or LI/RI/CQI or CRI/RI/CQI or CRI/LI/RI/CQI.

In one example, the first CSI report corresponds to a first portion of a CSI report, and the second CSI report corresponds to a second portion of the CSI report, where the CSI report has a reportQuantity=RI/PMI/CQI or LI/RI/PMI/CQI or CRI/RI/PMI/CQI or CRI/LI/RI/PMI/CQI or RI/CQI or LI/RI/CQI or CRI/RI/CQI or CRI/LI/RI/CQI.

In one example, when the first CSI report corresponds to CJT calibration reporting with ‘reportQuantity’ set to ‘cjtc-Dd’ and the second CSI report corresponds to Rel-18 CJT CSI reporting with ‘codebookType’ set to ‘typeII-CJT-r18’, the UE determines PMI for the Rel-18 eType-II CJT CSI report assuming pre-compensation using the UE reported delay offset of the first CSI report.

In one example, when the first CSI report corresponds to CJT calibration reporting with ‘reportQuantity’ set to ‘cjtc-F’ and the second CSI report corresponds to Rel-18 CJT CSI reporting with ‘codebookType’ set to ‘typeII-CJT-r18’, the UE determines PMI for the Rel-18 eType-II CJT CSI report assuming pre-compensation using the UE reported frequency offset of the first CSI report.

In one example, when the first CSI report corresponds to CJT calibration reporting with ‘reportQuantity’ set to ‘cjtc-Dd’ and the second CSI report corresponds to (Rel-19) Type-I MP CSI reporting with ‘codebookType’ set to ‘typeI-MultiPanel-r19’, the UE determines PMI for the (Rel-19) Type-I MP CSI report assuming pre-compensation using the UE reported delay offset of the first CSI report.

In one example, when the first CSI report corresponds to CJT calibration reporting with ‘reportQuantity’ set to ‘cjtc-F’ and the second CSI report corresponds to (Rel-19) Type-I MP CSI reporting with ‘codebookType’ set to ‘typeI-MultiPanel-r19’, the UE determines PMI for the (Rel-19) Type-I MP CSI report assuming pre-compensation using the UE reported frequency offset of the first CSI report.

In one embodiment, a UE is configured with a separate trigger or a joint trigger via an RRC parameter, where the RRC parameter indicates a triggering scheme either the separate trigger or the joint trigger for first and second CSI reports that are configured being linked/associated. In one example, when the RRC parameter indicates e.g., ‘separate’, the first CSI report and the second CSI report are configured to be separately triggered (with different trigger states). In one example, when the RRC parameter indicates e.g., ‘joint, the first CSI report and the second CSI report are configured to be jointly triggered (with a same trigger state).

In one example, an RRC parameter to indicate a joint trigger or a separate trigger is included in IE CSI-AperiodicTriggerState or CSI-AssociatedReportConfigInfo.

‘triggeringScheme’ is used for the parameter in this disclosure, but it can be used under another name. In one example, the parameter can be implemented using ENUMERATED operation with ‘separate triggering’ or ‘joint triggering’. In one example, it can be as follows:

| | |
|---|---|
| CSI-Aperiodic TriggerState ::= | SEQUENCE { |

| | |
|---|---|
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | | |
|---|---|---|
| ap-CSI-MultiplexingMode-r17 | ENUMERATED {enabled} | OPTIONAL |

```
-- Need R
  ]],
  [[
```

| | |
|---|---|
| ltm-AssociatedReportConfigInfo-r18 LTM-CSI-ReportConfigId-r18 | OPTIONAL |

```
-- Need R
  ]]
  ...
```

| | | |
|---|---|---|
| triggeringScheme | ENUMERATED {separate, joint} | OPTIONAL -- Need X |

}

where ‘X’ of Need X corresponds to ‘S’, or ‘M’, or ‘N’, or ‘R’.

In another example, the parameter can be implemented in IE CSI-AssociatedReportConfigInfo. For example, it can be as follows:

CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF |

TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

```
  },
  ...
```

| | |
|---|---|
| applyIndicatedTCI-State2-r18 | CHOICE { |
| perSet-r18 | ENUMERATED {first, second}, |
| perResource-r18 | SEQUENCE (SIZE(1..maxNrofAP-CSI-RS-ResourcesPerSet)) OF |

ENUMERATED {first, second}

| | |
|---|---|
| } | OPTIONAL, -- Cond SecondCSICMR |
| csi-ReportSubConfigTriggerList-r18 | CSI-ReportSubConfigTriggerList-r18 |

```
OPTIONAL -- Need R
  ]]
  ...
```

| | | |
|---|---|---|
| triggeringScheme | ENUMERATED {separate, joint} | OPTIONAL -- Need X |

}

where ‘X’ of Need X corresponds to ‘S’, or ‘M’, or ‘N’, or ‘R’.

In one example, an RRC parameter to indicate a joint trigger or a separate trigger is included in IE CSI-ReportConfig. Similarly, it can be implemented using ENUMERATED operation with ‘separate triggering’ or ‘joint triggering’. In one example, it can be as follows:

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

...

| | | |
|---|---|---|
| triggeringScheme | ENUMERATED {separate, joint} | OPTIONAL -- Need X |

where ‘X’ of Need X corresponds to ‘S’, or ‘M’, or ‘N’, or ‘R’.

In one embodiment, an RRC parameter to indicate ‘separate triggering’ or ‘joint triggering’ is not introduced.

In one embodiment, when a first CSI report and a second CSI report are configured with a separate trigger, a UE is configured with an RRC parameter where the RRC parameter indicates whether or not the UE computes the second CSI report based on the first CSI report (i.e., pre-compensation). In one example, the RRC parameter is included in IE CSI-AperiodicTriggerState or IE CSI-AssociatedReportConfigInfo. In one example, the first CSI report corresponds to Rel-19 CJT calibration reporting, e.g., reportQuantity set to ‘cjtc-Dd’, ‘cjtc-F’, ‘cjtc-P’, or ‘cjtc-Dd-F’, and the second CSI report corresponds to Rel-18 CJT CSI reporting.

In one example, the RRC parameter is a 1-bit RRC parameter for each of N_{TRP} CSI-RS resources (resource-specific), where the N_{TRP} CSI-RS resources are the CSI-RS resources that are configured as channel measurement resource (CMR) in a resource setting associated with the second CSI report, e.g., Rel-18 CJT CSI reporting. In one example, the RRC parameter can be implemented under a name, e.g., delayOffsetCompensation, but it can be under another name. In one example, the RRC parameter can be implemented as follows:

| | |
|---|---|
| CSI-AperiodicTriggerState ::= | SEQUENCE { |

| | |
|---|---|
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | | |
|---|---|---|
| ap-CSI-MultiplexingMode-r17 | ENUMERATED {enabled} | OPTIONAL -- Need R |

```
  ]],
  [[
```

| | | |
|---|---|---|
| ltm-AssociatedReportConfigInfo-r18 | LTM-CSI-ReportConfigId-r18 | OPTIONAL -- Need R |

```
  ]]
  ...
```

| | |
|---|---|
| delayOffsetCompensation | SEQUENCE (SIZE(1..maxNrofTRPs)) OF ENUMERATED |
| {enabled} | OPTIONAL -- Need X |

}

where maxNrofTRPs is an integer value greater than or equal to 4, and ‘X’ of Need X corresponds to ‘S’, or ‘M’, or ‘N’, or ‘R’. In one example, maxNrofTRPs=4.

In one example, the 1-bit RRC parameter to enable or not is associated with a corresponding CSI-RS resource, and hence, the UE computes the second CSI report based on the first CSI report associated with the CSI-RS resources corresponding to the RRC parameters set to enabled and not based on the first CSI report associated with the CSI-RS resources corresponding to the RRC parameters set to not enabled.

In another example, the parameter can be implemented in IE CSI-AssociatedReportConfigInfo. For example, it can be as follows:

CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF |

TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

```
  },
  ...
```

| | |
|---|---|
| applyIndicatedTCI-State2-r18 | CHOICE { |
| perSet-r18 | ENUMERATED {first, second} |
| perResource-r18 | SEQUENCE (SIZE(1..maxNrofAP-CSI-RS-ResourcesPerSet)) OF |

ENUMERATED {first, second}

| | |
|---|---|
| } | OPTIONAL, -- Cond SecondCSICMR |
| csi-ReportSubConfigTriggerList-r18 | CSI-ReportSubConfigTriggerList-r18 |

```
OPTIONAL -- Need R
  ]]
  ...
```

| | |
|---|---|
| delayOffsetCompensation | SEQUENCE (SIZE(1..maxNrofTRPs)) OF ENUMERATED |
| {enabled} | OPTIONAL -- Need X |

}

where maxNrofTRPs is an integer value greater than or equal to 4, and ‘X’ of Need X corresponds to ‘S’, or ‘M’, or ‘N’, or ‘R’. In one example, maxNrofTRPs=4.

In one example, the RRC parameter is a 1-bit RRC parameter for each of N_{TRP}-1 CSI-RS resources excluding a reference CSI-RS resource (resource-specific), where the N_{TRP} CSI-RS resources are the CSI-RS resources that are configured as CMR in a resource setting associated with the second CSI report, e.g., Rel-18 CJT CSI reporting. In one example, the RRC parameter can be implemented under a name, e.g., delayOffsetCompensation, but it can be under another name. In one example, the RRC parameter can be implemented as follows:

| | |
|---|---|
| CSI-AperiodicTriggerState ::= | SEQUENCE { |

| | |
|---|---|
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | | |
|---|---|---|
| ap-CSI-MultiplexingMode-r17 | ENUMERATED {enabled} | OPTIONAL -- Need R |

```
  ]],
  [[
```

| | | |
|---|---|---|
| ltm-AssociatedReportConfigInfo-r18 | LTM-CSI-ReportConfigId-r18 | OPTIONAL -- Need R |

```
  ]]
  ...
```

| | |
|---|---|
| delayOffsetCompensation | SEQUENCE (SIZE(1..maxNrofTRPs-1)) OF ENUMERATED |
| {enabled} | OPTIONAL -- Need X |

}

where maxNrofTRPs-1 is an integer value greater than or equal to 3, and ‘X’ of Need X corresponds to ‘S’, or ‘M’, or ‘N’, or ‘R’. In one example, max NrofTRPs-1=3.

In another example, the parameter can be implemented in IE CSI-AssociatedReportConfigInfo. For example, it can be as follows:

CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF |

TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

```
  },
  ...
```

| | |
|---|---|
| applyIndicatedTCI-State2-r18 | CHOICE { |
| perSet-r18 | ENUMERATED {first, second}, |
| perResource-r18 | SEQUENCE (SIZE(1..maxNrofAP-CSI-RS-ResourcesPerSet)) OF |

ENUMERATED {first, second }

| | |
|---|---|
| } | OPTIONAL, -- Cond SecondCSICMR |
| csi-ReportSubConfigTriggerList-r18 | CSI-ReportSubConfigTriggerList-r18 |

```
OPTIONAL -- Need R
  ]]
  ...
```

| | |
|---|---|
| delayOffsetCompensation | SEQUENCE (SIZE(1..maxNrofTRPs-1)) OF ENUMERATED |
| {enabled} | OPTIONAL -- Need X |

}

maxNrofTRPs-1 is an integer value greater than or equal to 3, and ‘X’ of Need X corresponds to ‘S’, or ‘M’, or ‘N’, or ‘R’. In one example, maxNrofTRPs-1=3.

In one example, the RRC parameter is a 1-bit RRC parameter, regardless N_{TRP} CSI-RS resources (resource-common). In one example, the RRC parameter can be implemented under a name, e.g., delayOffsetCompensation, but it can be under another name. In one example, the RRC parameter can be implemented as follows:

| | |
|---|---|
| CSI-Aperiodic TriggerState ::= | SEQUENCE { |

| | |
|---|---|
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | | |
|---|---|---|
| ap-CSI-MultiplexingMode-r17 | ENUMERATED {enabled} | OPTIONAL -- Need R |

```
  ]],
  [[
```

| | | |
|---|---|---|
| ltm-AssociatedReportConfigInfo-r18 | LTM-CSI-ReportConfigId-r18 | OPTIONAL -- Need R |

```
  ]]
  ...
```

| | | |
|---|---|---|
| delayOffsetCompensation | ENUMERATED {enabled} | OPTIONAL -- Need X |

}

where ‘X’ of Need X corresponds to ‘S’, or ‘M’, or ‘N’, or ‘R’.

In another example, the parameter can be implemented in IE CSI-AssociatedReportConfigInfo. For example, it can be as follows:

CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF |

TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

```
  },
  ...
```

| | |
|---|---|
| applyIndicatedTCI-State2-r18 | CHOICE { |
| perSet-r18 | ENUMERATED {first, second}, |
| perResource-r18 | SEQUENCE (SIZE(1..maxNrofAP-CSI-RS-ResourcesPerSet)) OF |

ENUMERATED {first, second}

| | |
|---|---|
| } | OPTIONAL, -- Cond SecondCSICMR |
| csi-ReportSubConfigTriggerList-r18 | CSI-ReportSubConfigTriggerList-r18 |

```
OPTIONAL -- Need R
  ]]
  ...
```

| | | |
|---|---|---|
| delayOffsetCompensation | ENUMERATED {enabled} | OPTIONAL -- Need X |

}

where ‘X’ of Need X corresponds to ‘S’, or ‘M’, or ‘N’, or ‘R’.

In one embodiment, when a first CSI report and a second CSI report are configured with a separate trigger, a UE is configured with an RRC parameter, where the RRC parameter indicates an association (or a mapping) among CMRs for the first and second CSI reports.

In one example, when the numbers of CSI-RS resources/resource sets for the first and second CSI reports are the same, a fixed correspondence between the set of resource/resource set IDs in sequential order and the set of CSI-RS resource/resource set IDs in sequential order of configuration in their respective Resource Setting is applied/utilized/considered. (hence no need of a new RRC parameter)

In one example, when the number of CSI-RS resource/resource sets N_{CSI1} for the first CSI report is larger than the number of CSI-RS resources/resource N_{CSI2} for the second CSI report, (i.e., N_{CSI1}>N_{CSI2}) an RRC parameter is introduced to define an association or a mapping between the set of resource/resource set IDs and the set of CSI-RS resource/resource set IDs in their respective resource setting.

In one example, the RRC parameter is included in IE CSI-ResourceConfig or IE NZP-CSI-RS-ResourceSet, and the RRC parameter indicates which CSI-RS resource/resource set for the first CSI report being associated for each CSI-RS resource/resource set for the second CSI report. In one example, the RRC parameter can be implemented under a name of ‘cmrMappingForLinkage’, or it can be used under another name.

In one example, the RRC parameter can be implemented using a parameter of N_{CSI2}. [log₂(N_{CSI1})] bits.

In one example, the RRC parameter can be implemented using a parameter of

$$⌈ {log}_{2} \frac{{N}_{C S I 1} !}{( {N}_{C S I 1} - {N}_{C S I 2} ) !} ⌉ bits .$$

In one example, the RRC parameter can be implemented using a parameter of N_{CSI2}·2 bits.

In one example, the RRC parameter can be implemented as follows:

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId

OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |

```
  ...,
  [[
```

| | | |
|---|---|---|
| csi-SSB-ResourceSetListExt-r17 | CSI-SSB-ResourceSetId | OPTIONAL |

```
-- Need R
  ]]
  ...
```

| | |
|---|---|
| cmrMappingForLinkage | SEQUENCE (SIZE (1..Ncsi2)) OF INTEGER(1..Ncsi1) |

OPTIONAL -- Need X
}
-- TAG-CSI-RESOURCECONFIG-STOP
-- ASN1STOP

where ‘X’ of Need X corresponds to ‘S’, or ‘M’, or ‘N’, or ‘R’. In one example, Ncsi2-N_{CSI2} and Ncsi1=N_{CSI1}. In one example, Ncsi2 is a fixed integer value greater than or equal to 4 and Ncsi1 is a fixed integer value greater than or equal to 4. In one example, Ncsi2=4 and Ncsi1=4.

In one example, the RRC parameter can be implemented as follows:

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) |

OF NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |

```
  ...,
  ...
```

| | |
|---|---|
| cmrMappingForLinkage | SEQUENCE (SIZE (1..Ncsi2)) OF INTEGER(1..Ncsi1) |

OPTIONAL -- Need X
}

where ‘X’ of Need X corresponds to ‘S’, or ‘M’, or ‘N’, or ‘R’. In one example, Ncsi2-N_{CSI2} and Ncsi1=N_{CSI1}. In one example, Ncsi2 is a fixed integer value greater than or equal to 4 and Ncsi1 is a fixed integer value greater than or equal to 4. In one example, Ncsi2=4 and Ncsi1=4.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE shall assume the dynamic TRP selection is not enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE shall assume the dynamic TRP selection is enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE shall assume the dynamic TRP selection is not enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE shall assume the dynamic TRP selection is enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE shall assume the dynamic TRP selection is not enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE shall assume the dynamic TRP selection is enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is expected to be configured with enabling the dynamic TRP selection (e.g., restrictedCMR-selection being not enabled or not configured) for the CSI reporting.

In one embodiment, an indicator(s) is included in a CSI report (e.g., one example described in one or more embodiments herein), where the indicator is associated with a CLI report (one example described in this disclosure).

In one example, an indicator is a 1-bit (or X-bit, where X>1) indicator to indicate whether the CSI is calculated based on the associated CLI report or not. For example, the indicator has ‘0’ indicating the CSI is calculated without using the associated CLI report, and ‘1’ indicating the CSI is calculated based on the associated CLI report, or vice-versa.

In one example, an indicator is a 1-bit (or X-bit, where X>1) indicator to indicate whether the CSI cannot be (or is difficult to be, or is not) calculated based on the associated CLI report or not. For example, when there are delay offset values exceeding CP length, it is difficult to obtain the accurate CSI associated with the CLI report. In this case, the indicator can indicate the situation.

In one example, an indicator or a joint indicator (>1 bit) of indicating the above in the examples can be included in the CSI report. For example, the indicator has at least three states (e.g., at least 2 bit is needed) that state 1 indicates the CSI is calculated based on the associated CLI report, state 2 indicates the CSI is calculated without using the associated CLI report, and state 3 indicates the CSI can't be calculated using the associated CLI report.

In one embodiment, when linking a first CSI report and a second CSI report is configured with a joint triggering carried on a same PUSCH (e.g., an example in/under one or more embodiments described herein), the UCI associated with the first CSI report and the UCI associated with the second CSI report (i.e., UCI packing order) are according to at least one of the following examples.

In one example, the first CSI report corresponds to delay-offset reporting, e.g., with report quantity set to ‘cjtc-Dd’ or Rel-19 CJTC DO report.

In one example, the first CSI report corresponds to frequency-offset reporting, e.g., with report quantity set to ‘cjtc-F’ or Rel-19 CJTC FO report.

In one example, the first CSI report corresponds to frequency-offset reporting, e.g., with report quantity set to ‘cjtc-P’ or Rel-19 CJTC PO report.

In one example, the first CSI report corresponds to frequency-offset reporting, e.g., with report quantity set to ‘cjtc-Dd-F’ or Rel-19 CJTC DO and FO report.

In one example, the second CSI report corresponds to CJT CSI reporting, e.g., Rel-18 eType-II CJT CSI report.

The UCI associated with the first CSI report is placed in CSI Part 1, and then the UCI associated with the second CSI report is placed.

For example, when the first CSI report corresponds to CJTC DO reporting and the second CSI report corresponds to Rel-18 eType-II CJT CSI, the UCI packing order for the joint report is as follows: the UCI associated with CJTC DO reporting in CSI Part 1, then the UCI associated with Rel-18 eType-II CJT CSI.

The order of the UCI associated with CJTC DO reporting within in CSI Part 1 follows:
nref,
{D_{n,offset}, n=0, 1, . . . , N_{TRP}−1, n≠nref} ordered from the lowest to highest CSI-RS resource set ID.
{dₙ, n=0, 1, . . . , N_{TRP}−1, n≠nref} ordered from the lowest to highest CSI-RS resource set ID

The order of the UCI associated with Rel-18 eType-II CJT CSI (after the UCI associated with the CJTC DO report) follows the legacy UCI mapping order [7,8], which can be as follows: CSI Part 1→CSI Part 2 Group 0→CSI Part 2 Group 1→CSI Part 2 Group 2, for the UCI associated with Rel-18 eType-II CJT CSI.

In one example, the UCI omission rule for the Rel-18 eType-II CJT CSI is applied/utilized.

In another example, the UCI Part 1 associated with the second CSI report is placed in CSI Part 1, and then the UCI associated with the first CSI report is placed in CSI Part 1, and then the UCI Part 2 associated with the second CSI report is placed in CSI Part 2.

In another example, the UCI Part 1 associated with the second CSI report is placed in CSI Part 1, and then the UCI Part 2 associated with the second CSI report is placed in CSI Part 2, and then the UCI associated with the first CSI report is placed in CSI Part 1.

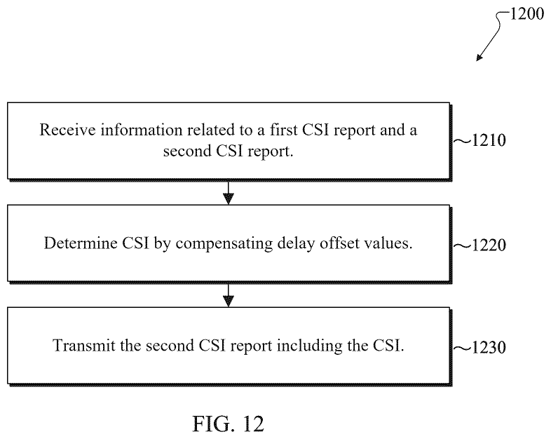

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE receiving information related to a first CSI report and a second CSI report (1210). For example, in 1200, the information indicates, for the first CSI report, N_{TRP} CSI-RS resource sets, N_{TRP}>1, and a report quantity set to ‘cjtc-Dd’ and, for the second CSI report, N_{TRP} CSI-RS resources and a codebook type set to ‘typeII-CJT-r18’. The first CSI report is associated with the second CSI report. The information for the second CSI report includes an aperiodic CSI trigger state and a first RRC parameter, ‘delayOffsetCompensation-r19’ set to ‘enabled’. In various embodiments, the first RRC parameter ‘delayOffsetCompensation-r19’ is included in an aperiodic CSI trigger state definition.

The UE then determines CSI by compensating delay offset values (1220). For example, in 1220, the determination is made based on the received information and the delay offset values are reported values in a latest report of the first CSI report. In various embodiments, the UE receives a CSI report configuration indicating a second RRC parameter, triggeringScheme. The second RRC parameter indicates separate triggering or joint triggering. For example, separate triggering indicates that the first and the second CSI reports are triggered separately. Joint triggering indicates that the first and the second CSI reports are triggered jointly. In various embodiments, the UE receives a CSI-RS resource set configuration including a second RRC parameter, cmrMappingForLinkage. The second RRC parameter indicates an association between resource set indexes for the first CSI report and resource indexes for the second CSI report. For example, the second RRC parameter indicates, for each CSI-RS resource of the second CSI report, an associated CSI-RS resource set of the first CSI report. The UE then transmits the second CSI report including the CSI (1230).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information related to a first channel state information (CSI) report and a second CSI report, the information indicating:
for the first CSI report, (i) N_{TRP} CSI reference signal (CSI-RS) resource sets, N_{TRP}>1, and (ii) a report quantity set to ‘cjtc-Dd’, and
for the second CSI report, (iii) N_{TRP} CSI-RS resources and (v) a codebook type set to ‘typeII-CJT-r18’, wherein:
the first CSI report is associated with the second CSI report,
the information for the second CSI report includes (i) an aperiodic CSI trigger state and (ii) a first radio resource control (RRC) parameter, ‘delayOffsetCompensation-r19’ set to ‘enabled’; and
a processor operably coupled to the transceiver, the processor configured to determine, based on the information, CSI by compensating delay offset values,
wherein the delay offset values are reported values in a latest report of the first CSI report, and
wherein the transceiver is further configured to transmit the second CSI report including the CSI.

2. The UE of claim 1, wherein the first RRC parameter ‘delayOffsetCompensation-r19’ is included in an aperiodic CSI trigger state definition.

3. The UE of claim 1, wherein:
the transceiver is further configured to receive a CSI report configuration indicating a second RRC parameter, triggeringScheme, and
the second RRC parameter indicates separate triggering or joint triggering.

4. The UE of claim 3, wherein:
separate triggering indicates that the first and the second CSI reports are triggered separately, and
joint triggering indicates that the first and the second CSI reports are triggered jointly.

5. The UE of claim 1, wherein:
the transceiver is further configured to receive a CSI-RS resource set configuration including a second RRC parameter, cmrMappingForLinkage, and
the second RRC parameter indicates an association between resource set indexes for the first CSI report and resource indexes for the second CSI report.

6. The UE of claim 5, wherein the second RRC parameter indicates, for each CSI-RS resource of the second CSI report, an associated CSI-RS resource set of the first CSI report.

7. A base station (BS) comprising:
a processor; and
a transceiver operably coupled to the processor, the transceiver configured to:
transmit information related to a first channel state information (CSI) report and a second CSI report, the information indicating:
for the first CSI report, (i) N_{TRP} CSI reference signal (CSI-RS) resource sets, N_{TRP}>1, and (ii) a report quantity set to ‘cjtc-Dd’, and
for the second CSI report, (iii) N_{TRP} CSI-RS resources and (v) a codebook type set to ‘typeII-CJT-r18’, wherein:
the first CSI report is associated with the second CSI report,
the information for the second CSI report includes (i) an aperiodic CSI trigger state and (ii) a first radio resource control (RRC) parameter, ‘delayOffsetCompensation-r19’ set to ‘enabled’; and
receive the second CSI report including CSI, wherein the CSI is based on compensation of delay offset values and wherein the delay offset values are reported values in a latest report of the first CSI report.

8. The BS of claim 7, wherein the first RRC parameter ‘delayOffsetCompensation-r19’ is included in an aperiodic CSI trigger state definition.

9. The BS of claim 7, wherein:
the transceiver is further configured to transmit a CSI report configuration indicating a second RRC parameter, triggeringScheme, and
the second RRC parameter indicates separate triggering or joint triggering.

10. The BS of claim 9, wherein:
separate triggering indicates that the first and the second CSI reports are triggered separately, and
joint triggering indicates that the first and the second CSI reports are triggered jointly.

11. The BS of claim 7, wherein:
the transceiver is further configured to transmit a CSI-RS resource set configuration including a second RRC parameter, cmrMappingForLinkage, and
the second RRC parameter indicates an association between resource set indexes for the first CSI report and resource indexes for the second CSI report.

12. The BS of claim 11, wherein the second RRC parameter indicates, for each CSI-RS resource of the second CSI report, an associated CSI-RS resource set of the first CSI report.

13. A method performed by a user equipment (UE), the method comprising:
receiving information related to a first channel state information (CSI) report and a second CSI report, the information indicating:
for the first CSI report, (i) N_{TRP} CSI reference signal (CSI-RS) resource sets, N_{TRP}>1, and (ii) a report quantity set to ‘cjtc-Dd’, and
for the second CSI report, (iii) N_{TRP} CSI-RS resources and (v) a codebook type set to ‘typeII-CJT-r18’, wherein:
the first CSI report is associated with the second CSI report,
the information for the second CSI report includes (i) an aperiodic CSI trigger state and (ii) a first radio resource control (RRC) parameter, ‘delayOffsetCompensation-r19’ set to ‘enabled’;
determining, based on the information, CSI by compensating delay offset values, wherein the delay offset values are reported values in a latest report of the first CSI report; and
transmitting the second CSI report including the CSI.

14. The method of claim 13, wherein the first RRC parameter ‘delayOffsetCompensation-r19’ is included in an aperiodic CSI trigger state definition.

15. The method of claim 13, further comprising:
receiving a CSI report configuration indicating a second RRC parameter, triggeringScheme,
wherein the second RRC parameter indicates separate triggering or joint triggering.

16. The method of claim 15, wherein:
separate triggering indicates that the first and the second CSI reports are triggered separately, and
joint triggering indicates that the first and the second CSI reports are triggered jointly.

17. The method of claim 13, further comprising:
receiving a CSI-RS resource set configuration including a second RRC parameter, cmrMappingForLinkage,
wherein the second RRC parameter indicates an association between resource set indexes for the first CSI report and resource indexes for the second CSI report.

18. The method of claim 17, wherein the second RRC parameter indicates, for each CSI-RS resource of the second CSI report, an associated CSI-RS resource set of the first CSI report.
